(19) United States
(12) Patent Application Publication
(10) Pub. No.: US 2005/0255955 A1
(43) Pub. Date: Nov. 17, 2005

(54) Internally meshing planetary gear mechanism

(76) Inventors: Haruo Arakawa, Kariya-city (JP); Takahisa Yokoyama, Kariya-city (JP); Takayuki Takeshita, Kariya-city (JP); Masashi Hori, Nishio-city (JP)

Correspondence Address: POSZ LAW GROUP, PLC, 12040 SOUTH LAKES DRIVE, SUITE 101, RESTON, VA, 20191, US

(21) Appl. No.: 11/110,824

(22) Filed: Apr. 21, 2005

(30) Foreign Application Priority Data
May 11, 2004 (JP) 2004-141070

(51) Int. Cl. F16H 1/32

(52) U.S. Cl. 475/162

(57) ABSTRACT

An eccentric portion of a first shaft is supported by a pair of roller bearings. If moments are generated by meshing of an externally toothed gear and an internally toothed gear and inner pins and inner pin holes that configure a rotation control mechanism, the pair of bearings provide two point support for the externally toothed gear. Accordingly, the externally toothed gear is supported so as not to tilt with respect to the first shaft, and a configuration is provided in which point contact does not occur in the meshing area of the externally toothed gear and the internally toothed gear.

### CROSS REFERENCE TO RELATED APPLICATION

This application is based upon and claims the benefit of Japanese Patent Application No. 2004-141070 filed on May 11, 2004, the content of which are incorporated herein by reference.

### FIELD OF THE INVENTION

The present invention relates to an internally meshing planetary gear mechanism used in a reduction gear or a speed increasing gear, and a support structure for a shaft of an externally toothed gear.

### BACKGROUND OF THE INVENTION

Related technology is known such as a structure for a speed increase-reduction gear disclosed in, for example, Japanese Patent Laid-Open Publication No. 2004-052928, which uses a trochoid gear. FIG. 13 shows the configuration of the disclosed speed increase-reduction gear in cross section.

The speed increase-reduction gear shown in FIG. 13 is an internally meshing planetary gear mechanism, and includes an externally toothed gear J4 that is rotatably attached to an eccentric portion J2 of an input shaft (first shaft) J1 via a bearing J3; and an internally toothed gear J6 that is fixed to a casing J5. A plurality of pin holes J10 are provided in a flange J8 that is integrally formed with an output shaft J7. A plurality of pins J9 formed in the externally toothed gear J4 are fitted into the plurality of pin holes J10.

With this configuration, rotational component of the externally toothed gear J4 generated by meshing of the externally toothed gear J4 and the internally toothed gear J6 is transmitted to and output by the output shaft J7 through engagement of the plurality of pins J9 and the plurality of holes J10.

However, in the related technology, a support structure for the externally toothed gear of the internally meshing planetary gear mechanism is not configured to take into account moment generated by meshing of the externally toothed gear J4 and the internally toothed gear J6 that acts in the direction that tilts the externally toothed gear J4 with respect to the input shaft J1. FIG. 14 will be used to explain this issue more concretely.

FIG. 14 shows the relationship of forces that act on the support structure of the externally toothed gear J4 of the internally meshing planetary gear mechanism of the related technology. FIG. 14 is an enlarged view of a section of FIG. 13.

Load is applied to the externally toothed gear J4 at load generation points shown in FIG. 14, namely, at the meshing area of the internally toothed gear J6 and the externally toothed gear J4 and the engagement positions of the pins J9 and the pin holes J10. An intersection point of a center axis of the bearing J3 and a center axis of the eccentric portion J2 provided on the first shaft J1 acts as a support point that supports load applied to the externally toothed gear J4. Accordingly, moments are generated that act in the rotational direction centering on the support point from each load generation point, or, in other words, moments acting in a direction that tilts the externally toothed gear J4 with respect to the input shaft.

Accordingly, when operating, the externally toothed gear J4 is tilted with respect to the first shaft J1, and excessive load is generated in the bearing J3. Thus, the bearing J3 has a tendency to fracture or break. Moreover, as a result of tilting of the externally toothed gear J4, instead of the originally intended line contact of the pins J9 and the pin holes J10 that perform a rotation control function, point contact at the meshing area of the externally toothed gear J4 and the internally toothed gear J6 occurs. Thus, surface pressure at these areas becomes excessive, and loss becomes substantial due to increase in the friction coefficient. Moreover, as a result of the point contact, problems occur related to shortening of the life expectancy of the contact areas.

### SUMMARY OF THE INVENTION

The invention has been conceived of in light of the above described problems, and it is an object thereof to provide an internally meshing planetary gear mechanism that improves mechanical efficiency and improves durability and the life expectancy of a gear mechanism by inhibiting generation of excessive surface pressure caused by point contact at the meshing area of an externally toothed gear and an internally toothed gear.

According to a first aspect of the invention, an externally toothed gear is supported so as to be freely rotatable with respect to a first shaft by at least two support points such that the externally toothed gear does not tilt with respect to the first shaft. The support points are (i) a first bearing provided between the first shaft and the externally toothed gear, and (ii) a support portion which is, one of, provided between the first shaft and the externally toothed gear, and provided beside an end surface of the externally toothed gear.

With this configuration, the externally toothed gear is supported by at least two support points, namely, the first bearing and the support portion. Accordingly, even if moments are generated by meshing areas of the externally toothed gear and the internally toothed gear, and a rotation control mechanism, the externally toothed gear is supported at two points. Thus, it is possible to support the externally toothed gear such that it does not tilt with respect to the first shaft.

Accordingly, point contact does not occur at the meshing area of the externally toothed gear and the internally toothed gear, which makes it is possible to inhibit the generation of excessive surface pressure at the meshing area. Thus, an internally meshing planetary gear mechanism is provided that enables both (a) mechanical efficiency to be improved, and (b) durability and life expectancy of the gear mechanism to be raised.

Further, a second bearing configuring the support portion may be provided between the first shaft and the externally toothed gear in addition to the first bearing. In this case, the first and the second bearings provide two points for supporting the externally toothed gear with respect to the first shaft.

Moreover, a regulating member which configures the support portion and which regulates movement of the end surface of the externally toothed gear in an axial direction of the first shaft may be provided. Accordingly, the first bearing and the regulating member provide two points for supporting the externally toothed gear with respect to the first shaft. In this case, as the regulating member, a thrust bearing may be disposed so as to face the end surface of the externally toothed gear. Alternatively, the regulation member may be configured by a portion of a wall surface of a housing that faces the end surface of the externally toothed gear.

### BRIEF DESCRIPTION OF THE DRAWINGS

Other objects, features and advantages of the present invention will be understood more fully from the following detailed description made with reference to the accompanying drawings. In the drawings:

FIG. 1 is a cross sectional view of a structure of an internally meshing planetary gear mechanism according to a first embodiment of the present invention;

FIG. 2 is an auxiliary cross sectional view taken along arrow A-A of FIG. 1;

FIG. 3 is an auxiliary cross sectional view taken along arrow B-B of FIG. 1;

FIG. 4 is an exploded view that shows the various structural elements of the internally meshing planetary gear mechanism of FIG. 1 prior to assembly when viewed from direction B of FIG. 1;

FIG. 5 is an exploded view that shows the various structural elements of the internally meshing planetary gear mechanism of FIG. 1 prior to assembly when viewed from direction A of FIG. 1;

FIG. 6 is an explanatory view of cycloid curves;

FIG. 7 is a schematic view illustrating moments that acts in the internally meshing planetary gear mechanism of FIG. 1;

FIG. 8 is a cross sectional view of a structure of an internally meshing planetary gear mechanism according to a second embodiment;

FIG. 9 is an auxiliary cross sectional view taken along arrow line C-C of FIG. 8;

FIG. 10 is an auxiliary cross sectional view taken along arrow line D-D of FIG. 8;

FIG. 11 is an exploded view that shows the various structural elements of the internally meshing planetary gear mechanism of FIG. 8 prior to assembly when viewed from direction A of FIG. 8;

FIG. 12 is an exploded view that shows the various structural elements of the internally meshing planetary gear mechanism of FIG. 8 prior to assembly when viewed from direction B of FIG. 8;

FIG. 13 shows a cross section of a speed increase-reduction gear disclosed in the related art; and

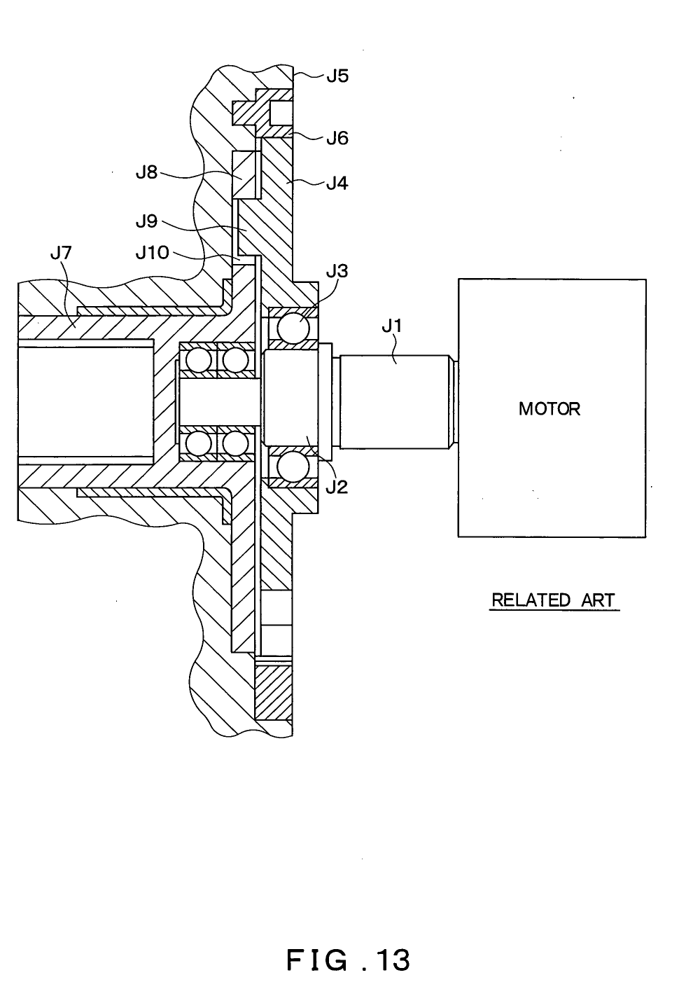

FIG. 14 is a schematic view illustrating moments that act in an internally meshing planetary gear mechanism disclosed in the related art.

### DETAILED DESCRIPTION OF THE PREFERRED EMBODIMENTS

The present invention will be described further with reference to various embodiments in the drawings.

### First Embodiment

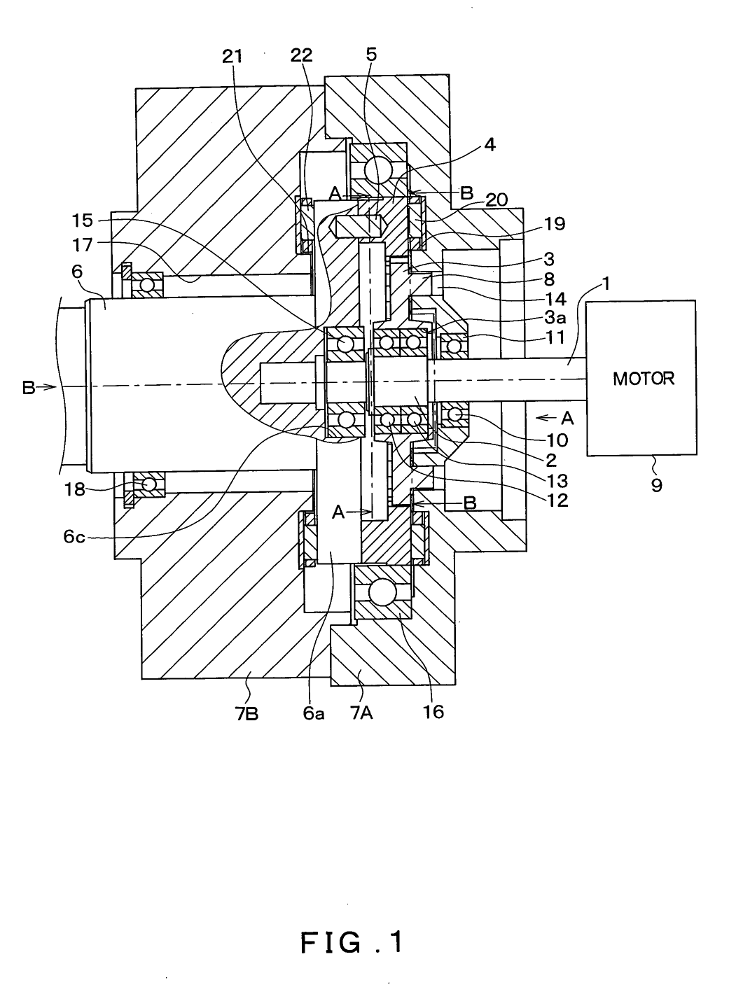

The structure of an internally meshing planetary gear mechanism to which a first embodiment of the invention is applied will be described with reference to FIGS. 1 to 5.

FIG.1 is a cross sectional view of the structure of the internally meshing planetary gear mechanism. The internally meshing planetary gear mechanism shown in the figure is, for example, used in a small sized, thin-profile reduction gear.

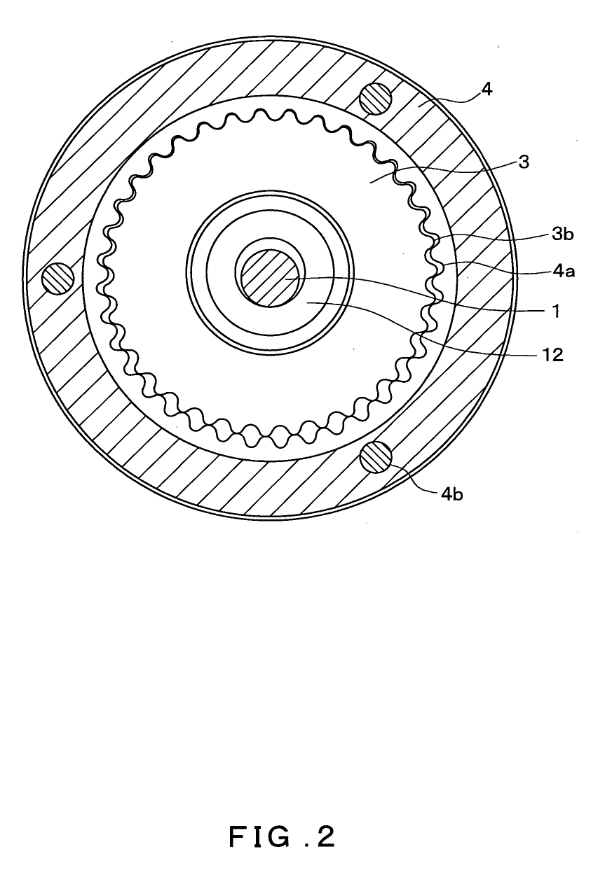

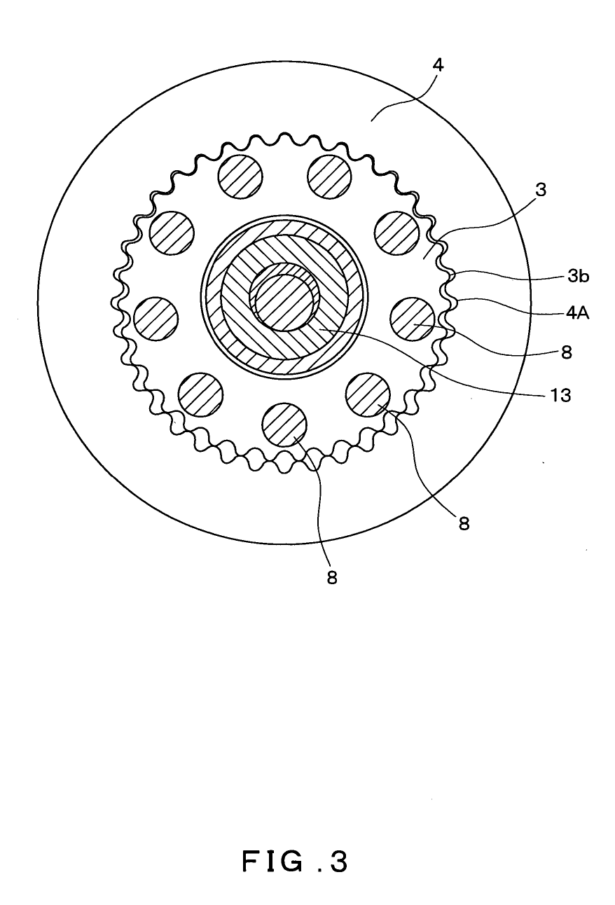

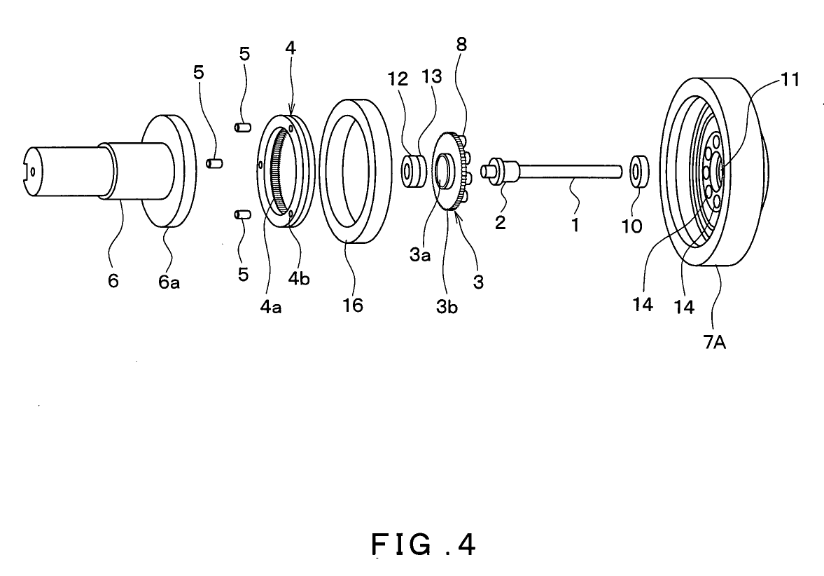

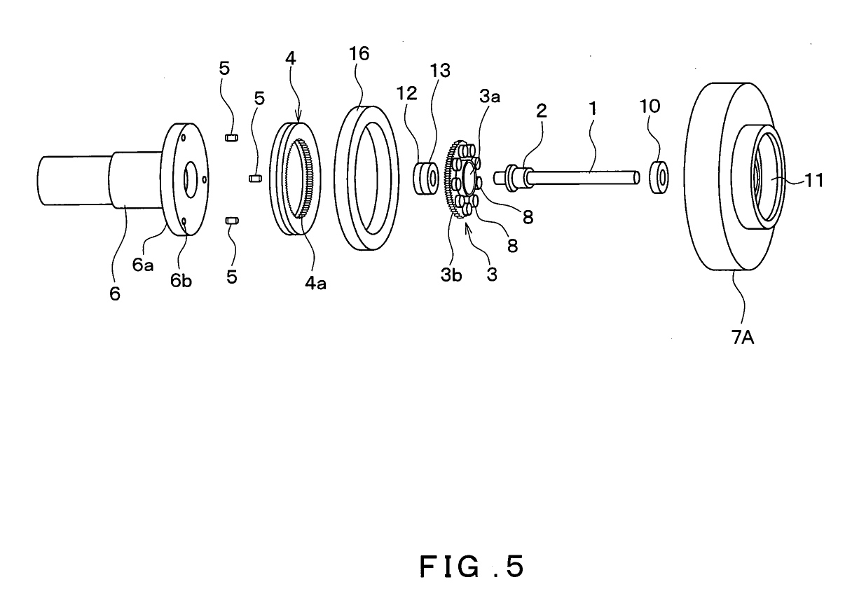

FIGS. 2 and 3 show respective auxiliary cross sectional views taken along arrows A-A and B-B of FIG. 1. FIGS. 4 and 5 are respective exploded views that show the various structural elements of the internally meshing planetary gear mechanism of FIG. 1 prior to assembly. FIG. 4 shows the structural members when viewed from direction B, and FIG. 5 shows that when viewed from direction A.

The internally meshing planetary gear mechanism shown in FIGS. 1 to 5 includes a first shaft 1, an eccentric portion 2, an externally toothed gear 3, an internally toothed gear 4, a plurality of knock pins 5, a second shaft 6, a housing including housings 7A and 7B, and a plurality of inner pins 8 configuring a rotation control mechanism.

The first shaft 1, as shown in FIG. 1, is driven by a motor 9 provided at the tip end thereof, and rotates along with rotation of the motor 9. Accordingly, the eccentric portion 2 provided at the other end of the first shaft 1 to the motor 9 is also rotated. The first shaft 1 is supported so as to be rotatable in an internal periphery wall surface of an opening 11 formed in the housings 7A and 7B by a bearing 10 provided coaxially with the first shaft 1.

The eccentric portion 2, as shown in FIG. 1, is attached to the opposite end of the first shaft 1 from the motor 9, and rotates eccentrically with respect to the first shaft 1 along with rotation thereof. This eccentric portion 2 is supported in the internal periphery wall surface of an opening 3a formed at a central position of the externally toothed gear 3 by a pair of bearings 12 and 13 provided coaxially with the eccentric portion 2. In the present embodiment, the pair of bearings 12 and 13 are roller bearings, and are lined up in the axial direction of the first shaft 1 so as to surround the external periphery of the eccentric portion 2.

The externally toothed gear 3, as can be seen from FIGS. 2 to 5, has a predetermined number of external teeth 3b formed in an external periphery surface thereof. In the present embodiment, the number of teeth 3b is, as an example, 35. The plurality of inner pins 8 are provided in an end surface of the externally toothed gear 3 at a side of the housing 7A thereof. The plurality of inner pins 8 are provided in a circular arrangement in a circumferential direction of the externally toothed gear 3. The plurality of inner pins 8 are, for example, formed with a column shape so as to protrude by a predetermined protrusion amount in the axial direction of the first shaft 1 from the end surface of the externally toothed gear 3 at a side of the housing 7A. Further, the plurality of pins 8 are fitted with a clearance for moving in a plurality of inner pin holes 14 provided in the housing 7A at positions that correspond with the plurality of pins 8. The plurality of inner pins 8 function as a rotation control mechanism that regulates rotation of the externally toothed gear 3 while permitting revolution thereof.

The internally toothed gear 4 is provided with internal teeth 4a that internally mesh with the external teeth 3b of the externally toothed gear 3. In the present embodiment, as an example, the number of internal teeth 4a is 36, which is one more than the number of the external teeth 3b. A plurality of holes 4b are formed in an end surface of the internally toothed gear 4 at a side of the housing 7B thereof. The plurality of knock pins 5 fitted into this plurality of holes 4b.

The knock pins 5 fit into the holes 4b of the internally toothed gear 4 so as to fix the internally toothed gear 4 to the second shaft 6. Accordingly, the knock pins 5 function so as to transmit and output the rotation imparted to the internally toothed gear 4 to the second shaft 6.

A flange 6a with a widened diameter is provided at a side of the first shaft 1 of the second shaft 6. The flange 6a is provided with holes 6b at positions that correspond to the holes 4b of the internally toothed gear 4 and into which the knock pins 5 are fitted. A cylindrical recess 6c is formed at a tip end position of the second shaft 6 at a side of the flange 6a thereof, and a bearing 15 that rotatably supports the tip end of the first shaft 1 is disposed within this cylindrical recess 6c. If, for example, the internally meshing planetary gear mechanism is used as a reduction gear as in the present embodiment, the opposite end of the second shaft 6 to the flange 6a is coupled to an actuator (not shown) that provides drive for a speed reduction operation.

The housings 7A and 7B function as both (i) a case for accommodating the externally toothed gear 3, the internally toothed gear 4 and the other structural elements, and (ii) a support for the first shaft 1 and the second shaft 6. A bearing 16 is positioned at an internal periphery surface of the housing 7A, and supports the internally toothed gear 4 so as hold it in a rotatable state. The second shaft 6 is fitted in an opening 17 of the housing 7B. A bearing 18 is provided coaxially with the second shaft 6 at an internal periphery surface of the housing 7B and rotatably supports the second shaft 6.

A ring-shaped groove 19 that faces the internally toothed gear 4 is formed in the internal periphery surface of the housing 7A at a side of the internally toothed gear 4 thereof. A thrust bearing 20 for supporting the internally toothed gear 4 is disposed in the groove 19. A ring-shaped groove 21 that faces the groove 19 is formed in the internal periphery wall of the housing 7B at the side of the flange 6a of the second shaft 6. A thrust bearing 22 for supporting the flange 6a is disposed in this groove 21.

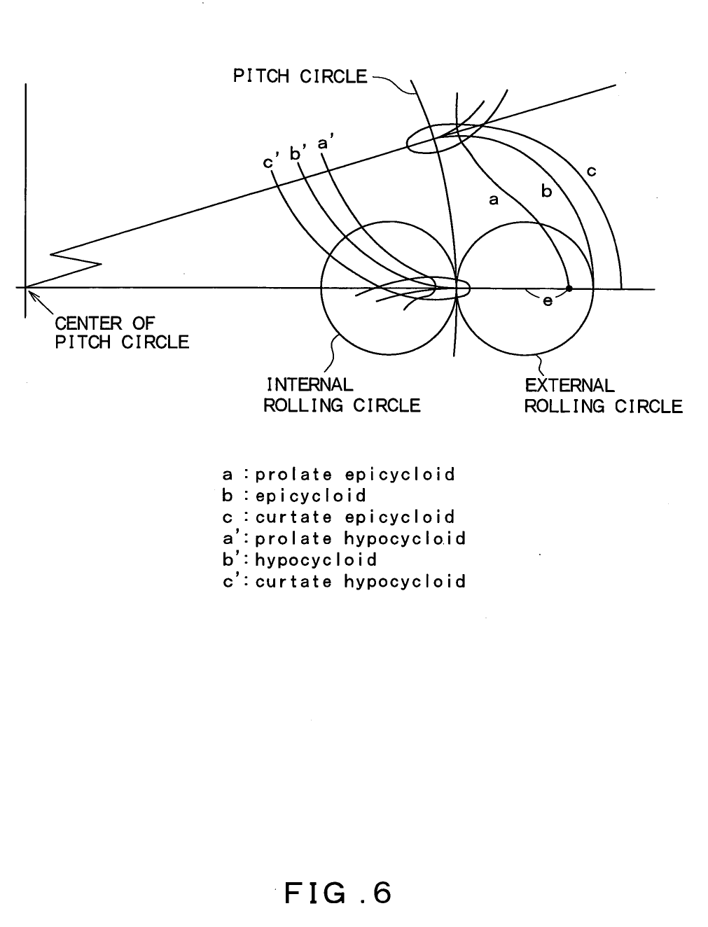

The internally meshing planetary gear mechanism configured as described above is designed based on cycloid curves for tooth tip shape, etc., of the external teeth 3b of the externally toothed gear 3 and the internal teeth 4a of the internally toothed gear 4. The definitions of the cycloid curves will be explained with reference to FIG. 6. The cycloid curves are shown in FIG. 6 as a, b, c, a′, b′ and c′. As can be seen, the paths of the cycloid curves are those traced by respective points in a radial direction of rolling circles, namely, an external rolling circle and an internal rolling circle, that roll without slipping on the arc of a pitch circle (base circle).

Amongst these, the paths traced by rolling of the external rolling circle are generally referred to as an epicycloid curves (a, b, c), and the paths traced by rolling of the internal rolling circle are generally referred to as hypocycloid curves (a′, b′, c′).

More specifically, the paths traced by the points at the inside of the rolling circles (the inside in the diameter direction) are called a prolate epicycloid curve (a) and a prolate hypocycloid curve (a′); and the paths traced by the points at the outside of the rolling circles (the outside in the diameter direction) are called a curtate epicycloid (c) and a curtate hypocycloid (c′).

Further, the paths traced by the points on the arcs of the rolling circles are simply called an epicycloid curve (b) and a hypocycloid curve (b′).

Note that, the terms epicycloid curve and the hypocycloid curve are taken here to indicate the epicycloid curve (b) and the hypocycloid curve (b′) that are traced by the points on the arcs of the rolling circles.

The tooth profiles of the externally toothed gear 3 and the internally toothed gear 4 are such that (i) the tooth profile at the inside of the pitch circle is set to be on the hypocycloid curve, and the tooth profile at the outside of the pitch circle is set to be on the epicycloid curve.

More specifically, the tooth profile of the externally toothed gear 3 and the internally toothed gear 4 are set such that: a teeth number of the externally toothed gear 3 is N; a diameter of the pitch circle of the externally toothed gear 3 is φD1; a number of teeth of the internally toothed gear 4 is M; a diameter of the pitch circle of the internally toothed gear 4 is φD2; a diameter of a rolling circle that traces the hypocycloid curve forming a tooth profile curve of the externally toothed gear 3 is φD1H; a diameter of a rolling circle that traces the epicycloid curve forming a tooth profile curve of the externally toothed gear 3 is φD1E; a diameter of a rolling circle that traces the hypocycloid curve forming a tooth profile curve of the internally toothed gear 4 is φD2H; and a diameter of a rolling circle that traces the epicycloid curve forming a tooth profile curve of the internally toothed gear 4 is φD2E. In this case, the following relationships are satisfied:

Equations
φD1/N=φD2/M
φD1H>φD1E
φD1H+φD1E=φD1/N
φD2H<φD2E
φD2H+φD2E=φD2/M
φD1H=φD2E
Given the relationships established by the above equations, the following relationships are satisfied:
Equations
φD1/N=φD2E/M
φD1H>φD1E
φD1H+φD1E=φD1/N
φD1/N=φD2/M
φD2H<φD2E
φD2H+φD2E=φD2/M

Accordingly, a predetermined clearance is provided between the externally toothed gear 3 and the internally toothed gear 4. The internally meshing planetary gear mechanism is driven by meshing the externally toothed gear 3 and the internally toothed gear 4 together with this clearance present.

Next, the operation of the internally meshing planetary gear mechanism with the above configuration will be described.

First, the motor 9 is driven to rotate the first shaft 1. At this time, the above described rotation control mechanism regulates the rotation of the externally toothed gear 3 with respect to the housing 7A such that only revolutionary movement is possible. In the present embodiment, the tooth number of the externally toothed gear 3 is 35 and the tooth number of the internally toothed gear 4 is 36. Accordingly, the meshing position of the externally toothed gear 3 and the internally toothed gear 4 is shifted by one tooth for each revolutionary cycle of the externally toothed gear 3.

Thus, when the first shaft 1 rotates once, the externally toothed gear 3 performs a single revolutionary movement and the meshing position of the externally toothed gear 3 and the internally toothed gear 4 shifts by one tooth. Accordingly, the internally toothed gear 4 rotates by 360/36 degrees, namely, 10 degrees, and the second shaft 6 that is fixed to the internally toothed gear 4 via the knock pins 5 is rotated by 10 degrees.

When the above configured internally meshing planetary gear mechanism is used as a reduction gear, the first shaft acts as the input shaft 1 and the second shaft 6 acts as the output shaft. As described previously, when the first shaft 1 performs one rotation, the externally toothed gear 3 performs one revolutionary movement. Accordingly, the internally toothed gear 4 rotates by 10 degrees, and the second shaft 6 rotates by 10 degrees. Thus, the reduction gear is configured such that the speed of the first shaft 1 that acts as the input shaft is reduced to a predetermined speed that is transmitted to the second shaft 6.

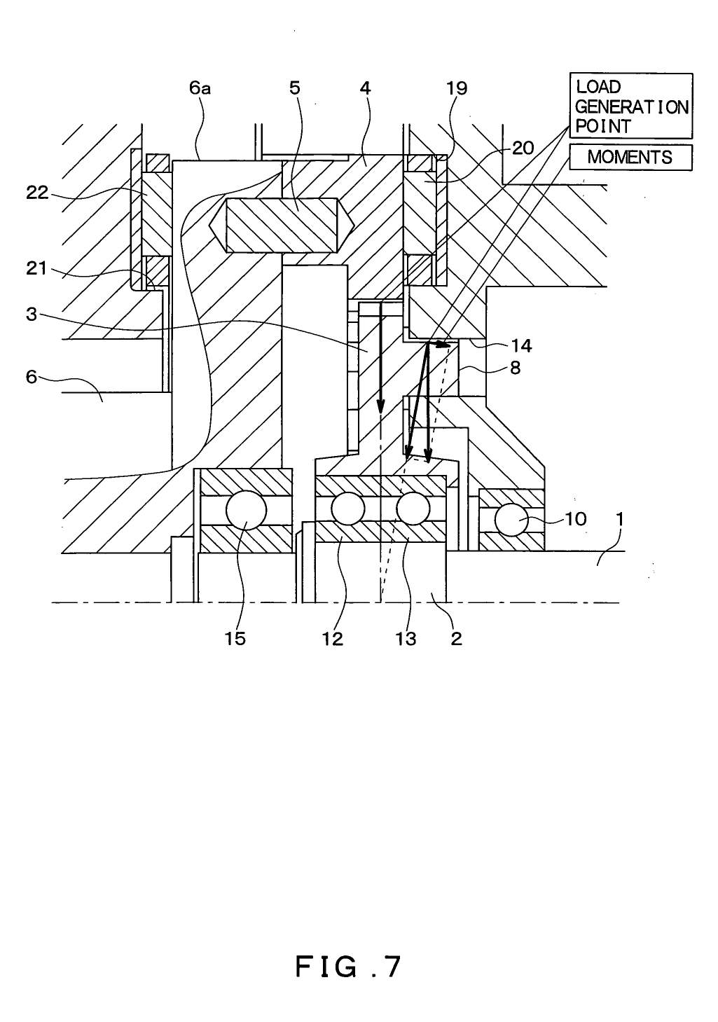

Note that, with the internally meshing planetary gear mechanism with the configuration of the above embodiment, the moments resulting from meshing of the above described the externally toothed gear 3 and the internally toothed gear 4, and the inner pins 8 and the inner pin holes 14 that configure the rotation control mechanism are generated in the manner described below. FIG. 7 is a schematic view illustrating the moments.

As can be seen from FIG. 7, at the load generation points of the internally meshing planetary gear mechanism of the present embodiment, namely, at the meshing areas of the externally toothed gear 3 and the internally toothed gear 4, and the engagement positions of the inner pins 8 and the inner pin holes 14, load is applied to the externally toothed gear 3. An intersection point of (i) a center line of the first shaft 1 and (ii) a line that passes through center positions of the bearings 12 and 13 acts as a support point that supports the load applied to the externally toothed gear 3. Accordingly, the moments are generated so as to act from each load generation point in the rotation direction centering on the support point, namely, in a direction that tilts the externally tooth gear 3 with respect to the first shaft 1.

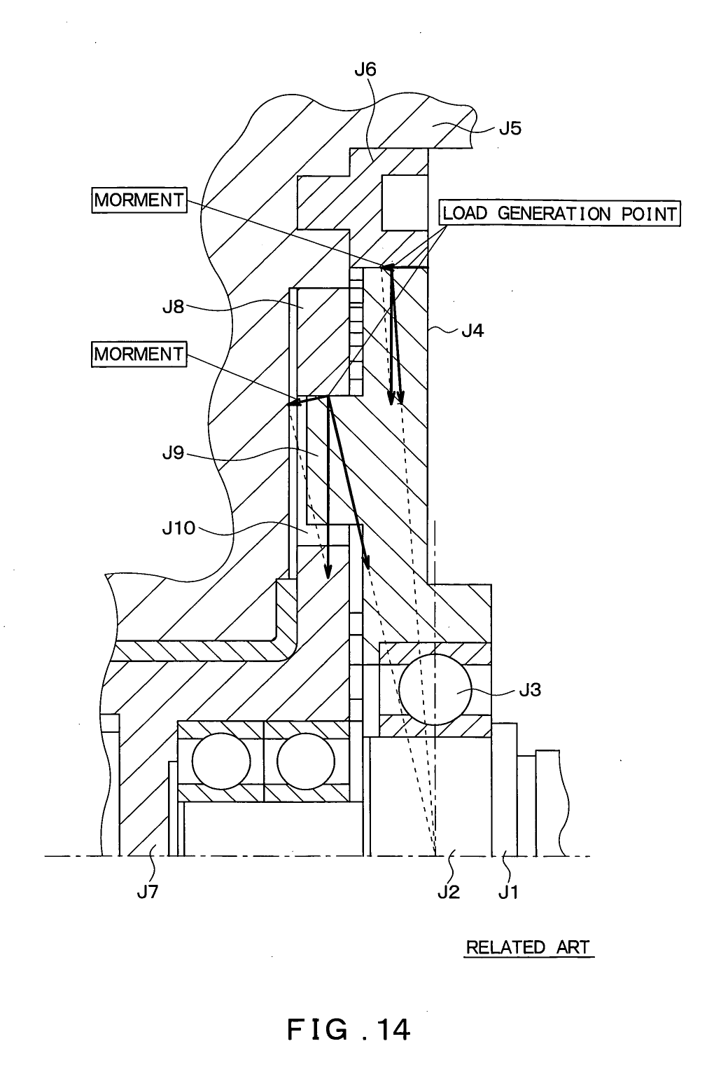

However, in the present embodiment, the eccentric portion 2 of the first shaft 1 is supported by the pair of bearings 12 and 13. Accordingly, even if moments are generated by meshing of the externally toothed gear 3 and the internally toothed gear 4, and the inner pins 8 and the inner pin holes 14 that configure the rotation control mechanism as shown in FIG. 14 described above, it is possible to support the externally toothed gear 3 at two points using the two bearings 12 and 13. Accordingly, the externally toothed gear 3 can be supported such that it does not tilt with respect to the first shaft 1.

Therefore, it is possible to provide a configuration in which point contact does not occur at the meshing area of externally toothed gear 3 and the internally toothed gear 4. Thus, the generation of excessive surface pressure at the meshing area is inhibited, and it is possible to provide an internally meshing planetary gear mechanism with (a) improved mechanical efficiency, (b) raised durability and life expectancy of the gear mechanism.

### Second Embodiment

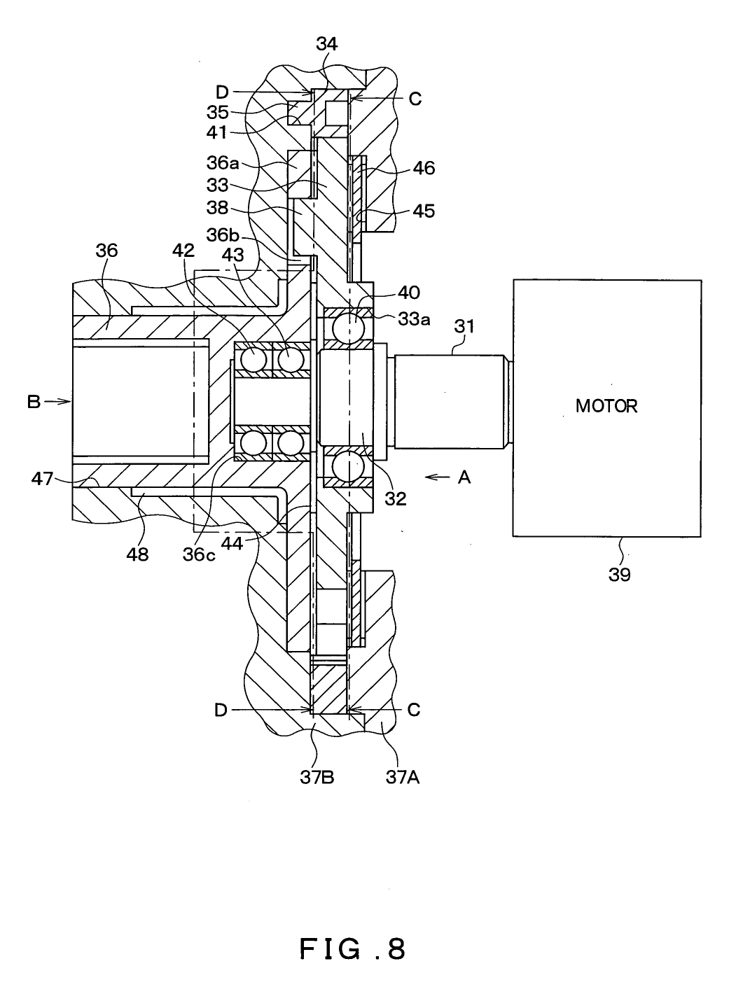

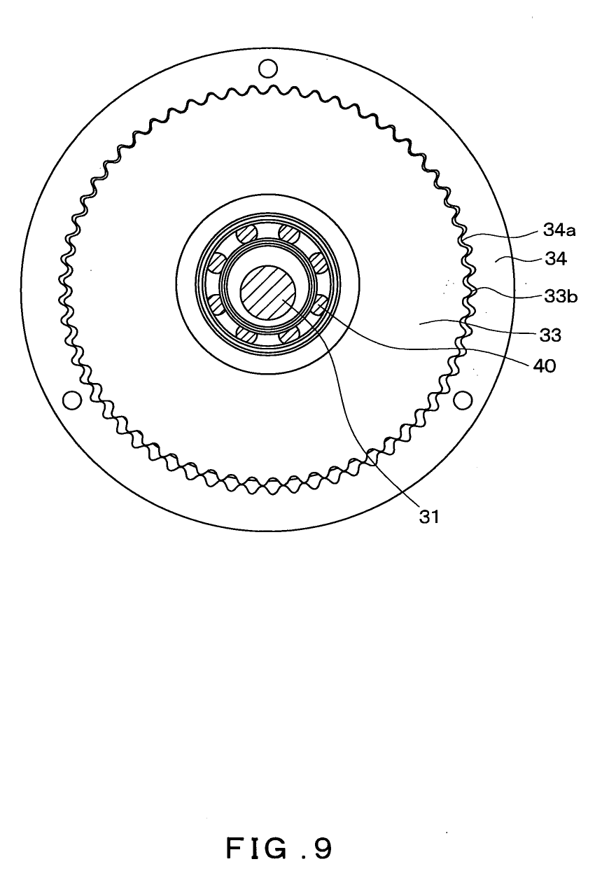

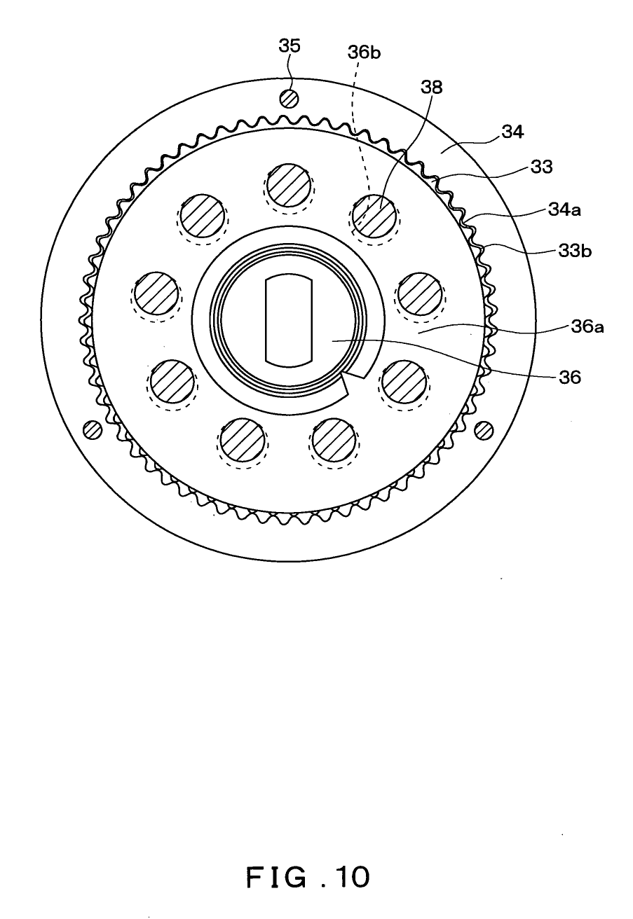

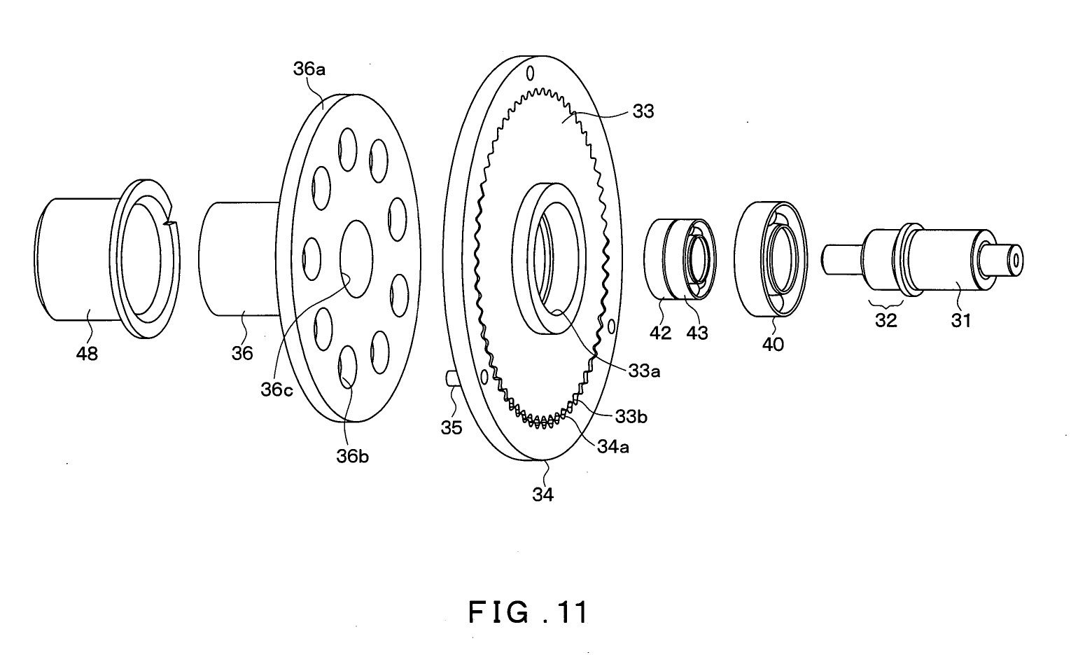

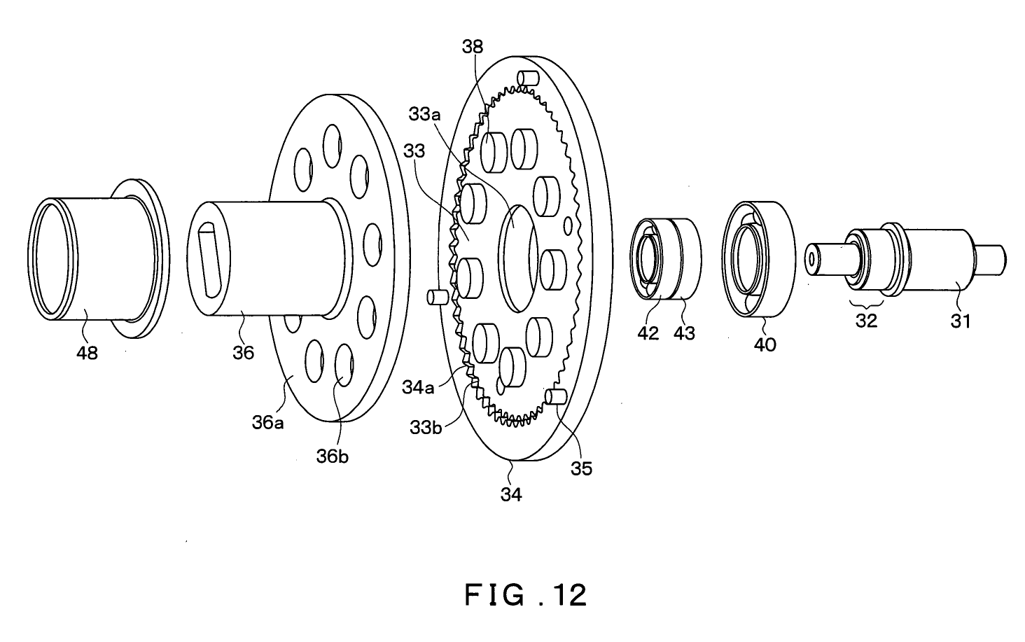

Next, a second embodiment of the present invention will be described with reference to the drawings. FIG. 8 is a cross sectional view of a structure of an internally meshing planetary gear mechanism according to the second embodiment. FIGS. 9 and 10 show, respectively, auxiliary cross sectional views taken along arrow line C-C and arrow line D-D of FIG. 8. FIGS. 11 and 12 show exploded views of the various structural elements of the internally meshing planetary gear mechanism of FIG. 8 prior to assembly, with FIG. 11 showing the view from direction A and FIG. 12 showing the view from direction B of FIG. 8.

The internally meshing planetary gear mechanism shown in FIGS. 8 to 12, includes a first shaft 31, an eccentric portion 32, an externally toothed gear 33, an internally toothed gear 34, fixing-use pins 35, a second shaft 36, housings 37A and 37B, and inner pins 38.

The first shaft 31, as shown in FIG. 8, is driven by a motor 39 provided at a tip end thereof, and rotates along with rotation of the motor 39. Accordingly, the eccentric portion 32 provided at the other end of the first shaft 31 to the motor 39 is also rotated.

The eccentric portion 32, as shown in FIG. 8, is attached to the opposite end of the first shaft 31 from the motor 39, and rotates eccentrically with respect to the first shaft 31 along with rotation thereof. This eccentric portion 32 is supported in an internal periphery wall surface of an opening 33a formed at a central position of the externally toothed gear 33 by a bearing 40 provided coaxially with the eccentric portion 32. In the present embodiment, the bearing 40 that supports the eccentric portion 32 is configured as a ball bearing, and surrounds the external periphery of the eccentric portion 32.

The externally toothed gear 33, as can be seen from FIGS. 9 to 12, has a predetermined number of external teeth 33b formed in an external periphery surface thereof. A plurality of inner pins 38 are provided in an end surface of the externally toothed gear 33 at a side of the second shaft 36 thereof. The plurality of inner pins 38 are provided in a circular arrangement in a circumferential direction of the externally toothed gear 33. The plurality of inner pins 38 are, for example, formed with a column shape so as to protrude by a predetermined protrusion amount in the axial direction of the first shaft 31 from the end surface of the externally toothed gear 33 at a side of the second shaft 36. Further, the plurality of pins 38 are respectively fitted with a clearance for moving in a plurality of inner pin holes 36b provided in a flange 36a of the second shaft 36, described hereinafter, at positions that correspond with the plurality of pins 38. The plurality of inner pins 38 function as a rotation control mechanism that regulates rotation of the externally toothed gear 33 while permitting revolution thereof.

The internally toothed gear 34 is provided with internal teeth 34a that internally mesh with the external teeth 33b of the externally toothed gear 33. In the present embodiment, as an example, the number of the internal teeth 34a is set to be one more than the number of the external teeth 33b of the externally toothed gear 33. The plurality of fixing-use pins 35 are formed in an end surface of the internally toothed gear 34 at a side of the housing 37B thereof. The plurality of fixing pins 35 are fitted into holes 41 formed in an internal wall of the housing 37B, whereby the internally toothed gear 34 is fixed to the housing 37B.

The second shaft 36 is provided with the flange 36a that has a widened diameter at a side of the first shaft 31 side thereof. A cylindrical recess 36c is formed at a tip end position of the second shaft 36 at a side of the flange 36a thereof, and bearings 42 and 43 that rotatably support the tip end of the first shaft 31 are disposed within this cylindrical recess 36c. A sliding bearing 44 is disposed between the flange 36a and the externally toothed gear 33 so as to surround the recess 36c of the second shaft 36. The sliding bearing 44 enables smooth sliding of the flange 36a and the externally toothed gear 33.

The opposite end of the second shaft 36 to the flange 36a is coupled to an actuator (not shown) that is driven with reduced speed by the present internally meshing planetary gear mechanism.

The housings 37A and 37B function as both (i) a case for accommodating the externally toothed gear 33, the internally toothed gear 34 and the other structural elements, and (ii) a support for the first shaft 31 and the second shaft 36. A stepped portion 45 is formed in a wall surface of the housing 37A that faces the end surface of the externally toothed gear 33. A thrust bearing 46 is disposed in the stepped portion 45, whereby tilting of the externally toothed gear 33 with respect to the first shaft 31 is inhibited. Moreover, the second shaft 6 is fitted in an opening 47 of the housing 37B. A bearing 48 is provided coaxially with the second shaft 36 at an internal periphery surface of the housing 37B and rotatably supports the second shaft 36.

Next, the operation of the internally meshing planetary gear mechanism with the above configuration will be described.

First, the first shaft 31 is driven to rotate by the motor 39. At this time, the above described rotation control mechanism regulates the rotation of the externally toothed gear 33, and the internally toothed gear 34 is fixed to the housing 37B. Accordingly, the externally toothed gear 33 is only permitted to perform revolutionary movement. At this time, for each single rotation of the externally toothed gear 33, the meshing position of the externally toothed gear 33 and the internally toothed gear 34 is shifted by one tooth as in the first embodiment.

Thus, every time the first shaft 31 rotates once, the number of degrees of rotation is determined by the respective numbers of teeth of the externally toothed gear 33 and the internally toothed gear 34.

Note that, with the internally meshing planetary gear mechanism with the configuration of the present embodiment, moments resulting from meshing of the externally toothed gear 33 and the internally toothed gear 34, and the inner pins 38 and the inner pin holes 36b that configure the rotation control mechanism are generated as shown in FIG. 14.

However, in the present embodiment, not only the eccentric portion 32 of the first shaft 31 is supported by the bearing 40, but also the end surface of the externally toothed gear 33 is supported by the thrust bearing 46. Accordingly, as described with regard to FIG. 14 above, even if the moments resulting from meshing of the externally toothed gear 33 and the internally toothed gear 34, and the inner pins 38 and the inner pin holes 36b that configure the rotation control mechanism are generated, the pair of bearings 40 and 46 provide two support points for the externally toothed gear 33. Thus, the externally toothed gear 33 can be supported such that it does not tilt with respect to the first shaft 31.

Therefore, it is possible to provide a configuration in which point contact does not occur at the meshing area of externally toothed gear 33 and the internally toothed gear 34. Thus, the generation of excessive surface pressure at this meshing area is inhibited, and it is possible to provide an internally meshing planetary gear mechanism with (a) improved mechanical efficiency, (b) raised durability and life expectancy of the gear mechanism.

### Other Embodiments

According to the first embodiment, the rotation control mechanism is configured by providing the inner pins 8 in the end surface of the externally toothed gear 3 and the inner pin holes 14 in the housing 7A. However, this is merely an example of one possible configuration. The rotation control mechanism may be configured such that, for example, the plurality of pin holes are provided in a ring-shaped arrangement on the end surface of the externally toothed gear 3 and the plurality of inner pins are provided in the housing 7A, with the inner pins being fitted with a clearance for moving in the pin holes.

Moreover, in the second embodiment, the rotation control mechanism is configured such that the inner pins 38 are provided in the externally toothed gear 33 and the inner pin holes 36b in the flange 36a. However, this is merely an example of one possible configuration. The rotation control mechanism may be configured such that, for example, the plurality of pin holes are provided in a ring-shaped arrangement on the externally toothed gear 33 and the plurality of inner pins are provided in the flange 36a, with the inner pins being fitted with a degree of play in the pin holes.

In the above described first and second embodiments, the internally meshing planetary gear mechanism is utilized as a reduction gear in which the first shafts 1 and 31 act as the input shaft; the second shafts 6 and 36 act as the output shaft; and the rotation control mechanism regulates the rotational movement of the externally toothed gears 3 and 33 such that revolutionary movement of the externally toothed gears 3 and 33 that accompanies rotation of the first shafts 1 and 31 is output to the second shafts 6 and 36. However, this is simply one example of a possible configuration, and the input and output relationships may be reversed so as to use the internally meshing planetary gear mechanism as a speed-increase gear.

Moreover, instead of using a pair of ball bearings for the bearings 12 and 13 as in the first embodiment, needle roller bearings that use a needle roller may be adopted. In this case, it is of course still possible to support the externally toothed gear 3 using surface support in which the externally toothed gear 3 is supported by at least two points. Accordingly, the same effects as described above can be achieved.

Moreover, the thrust bearing described with regard to the second embodiment may be adopted in the internally meshing planetary gear mechanism of the first embodiment. Further, instead of a thrust bearing, a stopper may be provided that regulates tilting of the externally toothed gear 3 with respect to the first shaft 1. For example, if a structure is adopted in which the inner wall surface of the housing 7A is in sliding contact with the externally toothed gear 3, the inner wall surface can perform a stopper function. In the case that a thrust bearing or a stopper of this type is provided, even if the bearings provided in the first embodiment are reduced to just one, it is possible to inhibit the externally toothed gear 3 from tilting with respect to the first shaft 1. Accordingly, the same effects as those of the first embodiment can be achieved.

Of course, even if the externally toothed gear 33 of the second embodiment is supported by a pair of ball bearings, a needle roller bearing, or a cylindrical bearing, it is possible to achieve the same effects as those of the first embodiment. Moreover, instead of a thrust bearing, a stopper may be provided that regulates tilting of the externally toothed gear 33 with respect to the first shaft 31.

While the above description is of the preferred embodiments of the present invention, it should be appreciated that the invention may be modified, altered, or varied without deviating from the scope and fair meaning of the following claims.

1. An internally meshing planetary gear mechanism comprising:
a first shaft provided with an eccentric portion;
an externally toothed gear coupled to the first shaft via the eccentric portion so as to be capable of eccentric rotation with respect to the first shaft;
an internally toothed gear that meshes internally with the externally toothed gear;
a housing that accommodates the externally toothed gear and the internally toothed gear;
a rotation control mechanism that controls the externally toothed gear such that it does not rotate with respect to the housing;
a second shaft which is provided coaxially with the first shaft and which outputs rotation of the externally toothed gear, wherein
the externally toothed gear is supported so as to be freely rotatable with respect to the first shaft by at least two support points such that the externally toothed gear does not tilt with respect to the first shaft, the support points being a bearing provided between the first shaft and the externally toothed gear, and a support portion which is, one of, provided between the first shaft and the externally toothed gear, and provided beside an end surface of the externally toothed gear.

2. The internally meshing planetary gear mechanism according to claim 1, wherein
a second bearing configuring the support portion is provided between the first shaft and the externally toothed gear in addition to the first bearing, and
the first and the second bearings provide two points for supporting the externally toothed gear with respect to the first shaft.

3. The internally meshing planetary gear mechanism according to claim 1, further comprising
a regulating member which configures the support portion and which regulates movement of the end surface of the externally toothed gear in an axial direction of the first shaft, and
the first bearing and the regulating member provide two points for supporting the externally toothed gear with respect to the first shaft.

4. The internally meshing planetary gear mechanism according to claim 3, wherein the regulating member is a thrust bearing disposed so as to face the end surface of the externally toothed gear.

5. The internally meshing planetary gear mechanism according to claim 3, wherein
the regulation member is configured from a portion of a wall surface of the housing that faces the end surface of the externally toothed gear.

6. The internally meshing planetary gear mechanism according to claim 1, wherein
respective tooth profiles of the internally toothed gear and the externally toothed gear are configured as cycloid curves.

7. An internally meshing planetary gear mechanism comprising:
a first shaft provided with an eccentric portion;
an externally toothed gear coupled to the first shaft via the eccentric portion so as to be capable of eccentric rotation with respect to the first shaft;
an internally toothed gear that meshes internally with the externally toothed gear;
a housing that accommodates the externally toothed gear and the internally toothed gear;
a second shaft that is coupled to the externally toothed gear via a transmission portion such that only a revolution component of the externally toothed gear is transmitted to the second shaft, wherein
the externally toothed gear is supported so as to be freely rotatable with respect to the first shaft by at least two support points such that the externally toothed gear does not tilt with respect to the first shaft, the support points being a first bearing provided between the first shaft and the externally toothed gear, and a support portion which is, one of, provided between the first shaft and the externally toothed gear, and provided beside an end surface of the externally toothed gear.

8. The internally meshing planetary gear mechanism according to claim 7, wherein
a second bearing configuring the support portion is provided between the first shaft and the externally toothed gear in addition to the first bearing, and
the first and the second bearings provide two points for supporting the externally toothed gear with respect to the first shaft.

9. The internally meshing planetary gear mechanism according to claim 7, further comprising
a regulating member which configures the support portion and which regulates movement of the end surface of the externally toothed gear in an axial direction of the first shaft, and
the first bearing and the regulating member provide two points for supporting the externally toothed gear with respect to the first shaft.

10. The internally meshing planetary gear mechanism according to claim 9, wherein
the regulating member is a thrust bearing disposed so as to face the end surface of the externally toothed gear.

11. The internally meshing planetary gear mechanism according to claim 9, wherein
the regulation member is configured from a portion of a wall surface of the housing that faces the end surface of the externally toothed gear.

12. The internally meshing planetary gear mechanism according to any one of claim 7, wherein
respective tooth profiles of the internally toothed gear and the externally toothed gear are configured as cycloid curves.
